(19) United States
(12) Patent Application Publication
(10) Pub. No.: US 2026/0296908 A1
(43) Pub. Date: Oct. 1, 2026

(54) SIMULTANEOUS PRODUCTION METHOD OF LITHIUM HYDROXIDE AND SULFURIC ACID

(71) Applicants: POSCO HOLDINGS INC., Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Wan Jae MYEONG, Sejong-si (KR); Hye Jeong KIM, Pohang-si (KR); Kyunghoon KIM, Yeosu-si (KR); Dong Soo KIM, Pohang-si (KR); Bae Mun SEO, Pohang-si (KR); Jin Yeop WI, Pohang-si (KR)

(73) Assignees: POSCO HOLDINGS INC., Pohang-si, Gyeongsangbuk-do (KR); RESEARCH INSTITUTE OF INDUSTRIAL SCIENCE & TECHNOLOGY, Pohang-si, Gyeongsangbuk-do (KR)

(21) Appl. No.: 19/477,580

(22) PCT Filed: Aug. 16, 2024
(86) PCT No.: PCT/KR2024/012250

§ 371 Date: Oct. 22, 2025

(30) Foreign Application Priority Data
Sep. 26, 2023 (KR) 10-2023-0128794

(51) Int. Cl. C01D 15/02; B01D 61/44; B01D 61/46; C01B 17/74

(52) U.S. Cl. CPC C01D 15/02; B01D 61/445; B01D 61/465; B01D 61/466; C01B 17/745

(57) ABSTRACT

A method for simultaneously preparing lithium hydroxide and sulfuric acid including preparing a bipolar membrane electrodialysis device including a first bipolar membrane, an anion exchange membrane, a cation exchange membrane, and a second bipolar membrane in which an acid chamber is formed between the first bipolar membrane and the anion exchange membrane, a salt chamber is formed between the anion exchange membrane and the cation exchange membrane, and a base chamber is formed between the cation exchange membrane and the second bipolar membrane; adding a lithium sulfate aqueous solution to the salt chamber, adding a sulfuric acid aqueous solution to the acid chamber, and adding a lithium hydroxide aqueous solution to the base chamber of the bipolar membrane electrodialysis device; and discharging a desalination solution formed in the salt chamber, discharging the sulfuric acid aqueous solution formed in the acid chamber, and discharging the lithium hydroxide aqueous

### TECHNICAL FIELD

The present disclosure relates to a method for simultaneously preparing lithium hydroxide and sulfuric acid, and more particularly, to a method for simultaneously preparing lithium hydroxide and sulfuric acid, which may prevent a decrease in current efficiency of a bipolar membrane electrodialysis process and reduce electricity consumption.

### BACKGROUND ART

Recently, due to the rapid growth of electric vehicle markets, a lithium secondary battery market for an electric vehicle is also explosively increasing. Accordingly, innovative technology for economically producing a lithium compound which is a raw material of a lithium secondary battery is being developed.

Among various methods for producing high-purity lithium hydroxide of a battery grade for an electric vehicle, in particular, electrochemical membrane separation technology for producing lithium hydroxide from a lithium salt is being actively developed.

Lithium hydroxide (LiOH) and sulfuric acid (H₂SO₄) may be simultaneously produced from a lithium salt, using a bipolar membrane electrodialysis method. When a lithium sulfate (Li₂SO₄) aqueous solution is added to a bipolar membrane electrodialysis tank and direct current is applied, lithium hydroxide (LiOH) and sulfuric acid (H₂SO₄) may be simultaneously produced. In this case, a lithium ion (Li⁺) and a sulfate ion (SO₄²⁻) dissociated from lithium sulfate pass through a cation exchange membrane and an anion exchange membrane, respectively. Meanwhile, the bipolar membrane dissociates water using applied current to produce proton (H⁺) and a hydroxide ion (OH⁺), the produced hydroxide ion migrates to a positive electrode (+) side and meets a lithium ion to form lithium hydroxide, and the produced proton migrates to a negative electrode (−) side and meets a sulfate ion to form sulfuric acid.

A proportion of current used for producing a target product to the applied current may be represented by current efficiency, and is calculated as follows:

Current efficiency (%)=100×(target ion production amount [mol])×Faraday constant [C/mol])/(current density [A/m²]×effective area of membrane [m²]×application time [sec])

There are various factors affecting current efficiency, and among them, performance of the physical properties of a cation exchange membrane, an anion exchange membrane, and a bipolar membrane used is important.

Meanwhile, since the current efficiency is directly related to production costs, development of technology for increasing current efficiency is needed.

### DISCLOSURE

### Technical Problem

The present disclosure attempts to provide a method for simultaneously preparing lithium hydroxide and sulfuric acid efficiently while increasing current efficiency. Specifically, the present disclosure attempts to provide a method for simultaneously preparing lithium hydroxide and sulfuric acid using bipolar membrane electrodialysis capable of improving current efficiency by controlling a migration amount of water and a lithium cation in an ion exchange membrane.

### Technical Solution

An exemplary embodiment of the present disclosure provides a method for simultaneously preparing lithium hydroxide and sulfuric acid including: preparing a bipolar membrane electrodialysis device including a first bipolar membrane, an anion exchange membrane, a cation exchange membrane, and a second bipolar membrane in which an acid chamber is formed between the first bipolar membrane and the anion exchange membrane, a salt chamber is formed between the anion exchange membrane and the cation exchange membrane, and a base chamber is formed between the cation exchange membrane and the second bipolar membrane; adding a lithium sulfate aqueous solution to the salt chamber, adding a sulfuric acid aqueous solution to the acid chamber, and adding a lithium hydroxide aqueous solution to the base chamber of the bipolar membrane electrodialysis device; and discharging a desalination solution formed in the salt chamber, discharging the sulfuric acid aqueous solution formed in the acid chamber, and discharging the lithium hydroxide aqueous solution formed in the base chamber of the bipolar membrane electrodialysis device.

A migration amount weight ratio between water (H₂O) and a lithium cation (Li⁺) in the cation exchange membrane of the bipolar membrane electrodialysis device may be 40 or less.

A ratio of a flow rate of the lithium hydroxide aqueous solution added to the base chamber to a flow rate of the lithium hydroxide aqueous solution discharged from the base chamber of the bipolar membrane electrodialysis device may be 0.3 to 0.6.

A ratio of a flow rate of the sulfuric acid aqueous solution added to the acid chamber to a flow rate of the sulfuric acid aqueous solution discharged from the acid chamber of the bipolar membrane electrodialysis device may be 0.9 to 1.2.

A current density passing through the cation exchange membrane and the anion exchange membrane of the bipolar membrane electrodialysis device may be 20 mA/cm² to 150 mA/cm².

A concentration of the lithium hydroxide aqueous solution added to the base chamber of the bipolar membrane electrodialysis device may be 0 mol/L to 1 mol/L, and a concentration of the lithium hydroxide aqueous solution discharged from the base chamber of the bipolar membrane electrodialysis device may be 1 mol/L to 5 mol/L.

A concentration of the sulfuric acid aqueous solution added to the acid chamber of the bipolar membrane electrodialysis device may be 0 mol/L to 0.5 mol/L, and a concentration of the sulfuric acid aqueous solution discharged from the acid chamber of the bipolar membrane electrodialysis device may be 0.5 mol/L to 3 mol/L.

A concentration of the lithium sulfate aqueous solution added to the salt chamber of the bipolar membrane electrodialysis device may be 0.5 mol/L to 2.5 mol/L, and a concentration of the lithium sulfate aqueous solution discharged from the salt chamber of the bipolar membrane electrodialysis device may be 0.1 mol/L to 2 mol/L.

The bipolar membrane electrodialysis device may be two or more serially connected electrodialysis stacks including the first bipolar membrane, the anion exchange membrane, the cation exchange membrane, and the second bipolar membrane in which the acid chamber is formed between the first bipolar membrane and the anion exchange membrane, the salt chamber is formed between the anion exchange membrane and the cation exchange membrane, and the base chamber is formed between the cation exchange membrane and the second bipolar membrane.

### Advantageous Effects

According to an exemplary embodiment of the present disclosure, current efficiency of a bipolar membrane electrodialysis process may be increased by controlling a migration amount of water and a lithium cation in an ion exchange membrane in the bipolar membrane electrodialysis process.

### DESCRIPTION OF THE DRAWINGS

FIG. 1 schematically shows a bipolar membrane electrodialysis (BPED) device according to an exemplary embodiment of the present disclosure.

FIG. 2 schematically shows a bipolar membrane electrodialysis (BPED) system used in an experiment of lithium hydroxide and sulfuric acid preparation of the present disclosure.

### BEST MODE FOR INVENTION

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

When it is mentioned that a part is “on” or “above” the other part, it means that the part is directly on or above the other part or another part may be interposed therebetween. In contrast, when it is mentioned that a part is “directly on” the other part, it means that nothing is interposed therebetween.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

In addition, unless otherwise particularly stated, % refers to wt %, and 1 ppm refers to 0.0001 wt %.

In the present specification, the term “combination(s) thereof” described in the Markush format refers to a mixture or combination of one or more selected from the group consisting of the constituent elements described in the Markush format, and refers to inclusion of one or more selected from the group consisting of the constituent elements.

Hereinafter, an exemplary embodiment of the present disclosure will be described in detail so that a person with ordinary skill in the art to which the present disclosure pertains may easily carry out the present disclosure. As those skilled in the art would realize, the described embodiments may be modified in various different ways, all without departing from the spirit or scope of the present disclosure.

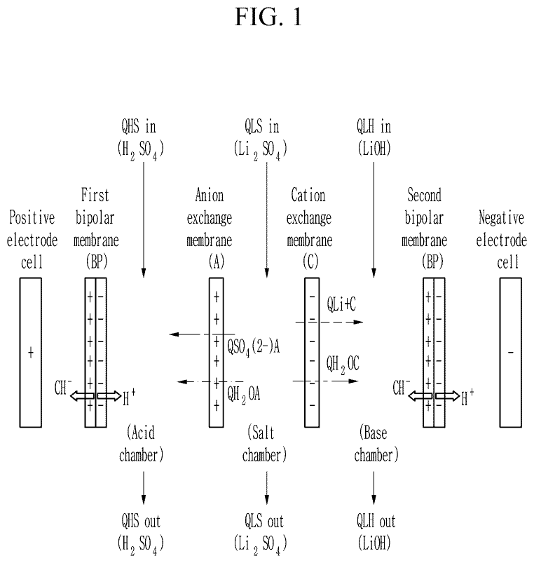

FIG. 1 schematically shows a bipolar membrane electrodialysis (BPED) device according to an exemplary embodiment of the present disclosure.

Referring to FIG. 1, the bipolar membrane electrodialysis device according to an exemplary embodiment of the present disclosure may include a unit pair which is positioned in a repeatedly laminating manner between a positive electrode cell and a negative electrode cell. The unit pair may have a triplet configuration in which a bipolar membrane, an anion exchange membrane, and a cation exchange membrane are sequentially positioned. Herein, specifically, it is a configuration in which the bipolar membrane, a spacer gasket, the anion exchange membrane, a spacer gasket, the cation exchange membrane, and a spacer gasket may be sequentially positioned. The unit pairs having the configuration may be positioned sequentially adjacent to each other. Among the two-unit pairs adjacent to each other, the spacer gasket positioned at a latter stage of the cation exchange membrane of the unit pair positioned in the front may be positioned adjacent to a bipolar membrane of the unit pair positioned adjacent to the latter stage.

Referring to FIG. 1, an acid chamber may be formed between a first bipolar membrane and the anion exchange membrane, and a salt chamber may be formed between the anion exchange membrane and the cation exchange membrane. In addition, a base chamber may be formed between the cation exchange membrane and a second bipolar membrane.

Hereinafter, a method for simultaneously preparing lithium hydroxide and sulfuric acid according to an exemplary embodiment of the present disclosure will be described.

First, bipolar electrodialysis may be performed by adding a lithium salt aqueous solution, specifically a lithium sulfate aqueous solution to a salt chamber of the unit pair, adding a low-concentration sulfuric acid aqueous solution including a sulfuric acid concentration of 0, which is an acid chamber reaction solution to an acid chamber, and adding a low-concentration lithium hydroxide aqueous solution including a lithium hydroxide concentration of 0, which is base chamber reaction solution to a base chamber.

Herein, when DC voltage is applied to the bipolar membrane electrodialysis device to allow current to flow, a sulfuric acid (H₂SO₄) aqueous solution is formed in the acid chamber between the first bipolar membrane and the anion exchange membrane, a lithium hydroxide (LiOH) aqueous solution is formed in the base chamber between the cation exchange membrane and the second bipolar membrane, and a desalination solution including a remaining lithium salt which has not migrate in an added lithium salt aqueous solution is formed in the salt chamber between the cation exchange membrane and the anion exchange membrane.

Specifically, a process of forming the sulfuric acid (H₂SO₄) and the lithium hydroxide (LiOH) is as follows.

When electricity is applied to the first bipolar membrane, water coming into the membrane from the acid chamber and the base chamber is dissociated to produce a hydrogen ion (H⁺) and a hydroxide ion (OH⁻). Herein, the hydroxide ion (OH⁻) produced by water dissociation migrates to the base chamber in the positive electrode (+) cell side, and the produced hydrogen ion (H⁺) migrates to the acid chamber between the first bipolar membrane and the anion exchange membrane. Meanwhile, the anion of the lithium salt aqueous solution added between the anion exchange membrane and the cation exchange membrane passes through the anion exchange membrane and migrates between the first bipolar membrane and the anion exchange membrane. Further, the hydrogen ion (H⁺) and the anion are concentrated between the first bipolar membrane and the anion exchange membrane and form a high-concentration sulfuric acid (H₂SO₄) aqueous solution. The acid chamber reaction solution in the present disclosure may be specifically a mixture of the sulfuric acid (H₂SO₄) aqueous solution and deionized water (DI water).

Next, a process of forming a lithium hydroxide (LiOH) aqueous solution is as follows. The second bipolar membrane dissociates entering water in the base chamber and the acid chamber to produce a hydrogen ion (H⁺) and a hydroxide ion (OH⁻). Herein, the hydrogen ion (H⁺) produced by water dissociation migrates to the acid chamber in the negative electrode (−) cell side, and the decomposed hydroxide ion (OH⁻) migrates to the base chamber between the second bipolar membrane and the anion exchange membrane. Meanwhile, a lithium ion (Li⁺) of the lithium salt aqueous solution added between the anion exchange membrane and the cation exchange membrane passes through the cation exchange membrane and migrates to the base chamber to add the lithium ion. Further, the hydroxide ion (OH⁻) and the lithium ion (Li⁺) are concentrated in the base chamber and form a high-concentration lithium hydroxide (LiOH) aqueous solution. The base chamber solution in the present disclosure may be specifically, a lithium hydroxide (LiOH) aqueous solution and/or deionized water (DI water).

More specifically, a sulfate anion (SO₄²⁻) meets a hydrogen ion (H⁺) from water dissociation in the bipolar membrane in the positive electrode cell side and is converted into an acid (H₂SO₄), and a lithium ion (Li⁺) migrating a negative electrode through a cation exchange membrane reacts with a hydroxide group (OH⁻) produced in the bipolar membrane and is converted into lithium hydroxide (LiOH).

In an exemplary embodiment of the present disclosure, the lithium salt may be specifically a sulfate (Li₂SO₄), and the acid may be sulfuric acid (H₂SO₄). Meanwhile, the acid chamber reaction solution may be low-concentration sulfuric acid (H₂SO₄) or water (deionized water), and the base chamber reaction solution may be a low-concentration lithium hydroxide aqueous solution or water (deionized water).

Herein, the entire reaction scheme may be as follows:

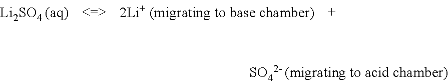

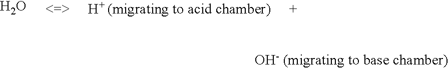

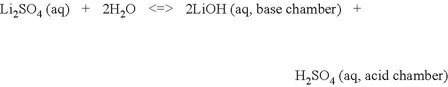

Herein, the high-concentration lithium salt aqueous solution added to the salt chamber may be discharged to the outside of the electrodialysis device by producing a low-concentration lithium salt aqueous solution partly remaining after the lithium ion and the acid group migrate and escape, that is, a desalination solution.

In addition, the lithium salt aqueous solution formed in the salt chamber is added to the unit pair positioned adjacent to the latter stage and the same electrodialysis as in the unit pair in the former stage may be performed.

Herein, as described above, in order to increase current efficiency when preparing the lithium hydroxide aqueous solution and the sulfuric acid aqueous solution from the lithium salt aqueous solution, a rate at which water (pure water) is dissociated in the bipolar membrane and a rate at which a lithium ion and an anion included in a lithium-containing aqueous solution migrate may be appropriately adjusted. In the case in which the rates are not appropriately adjusted, for example, in the case in which the dissociation rate of pure water (or deionized water) is higher than the migration rate of the lithium ion and the anion included in the lithium-containing aqueous solution, the dissociated hydrogen ion and hydroxide ion do not meet their zwitterions. Accordingly, ion migration for maintaining electrical neutrality occurs. Meanwhile, in a direction of ion migration, a direction of diffusion migration due to a concentration difference should be considered together with a direction of electric migration. For example, when the concentration of the hydroxide ion (OH⁻) of the base chamber of the cation exchange membrane is higher than the concentration of the hydroxide ion (OH⁻) of the salt chamber, diffusion migration of the hydroxide ion from the base chamber to the salt chamber occurs by diffusion. Since the direction of the diffusion migration is opposite to the direction of electricity migration, current efficiency is lowered. The cation exchange membrane may suppress back-diffusion (called back diffusion since the direction is opposite to the direction of electric migration) of the hydroxide group which is an anion to some extent by a Donnan exclusion force of a fixed anion (co-anion) inside. However, as the hydroxide concentration in the base chamber gradually increases, the back-diffusion to the salt chamber may also gradually increase to gradually decrease current efficiency

Therefore, in order to increase lithium hydroxide production current efficiency, it is important to adjust the water dissociation rate in the bipolar membrane and the lithium ion and anion migration rates and maintain a proper balance of the migrated ions with the water (H₂O) migration rate in the exchange membrane, by appropriately adjusting the physical properties of the anion exchange membrane, the bipolar membrane, and the cation exchange membrane.

Water migrates together when a lithium cation (Li⁺) migrates through a cation exchange membrane. When the amount of water (H₂O) migrating together is too large, a fixed anion density of the cation exchange membrane is decreased by swelling of the cation exchange membrane and a Donnan exclusion force to the hydroxide anion (OH⁻) is decreased, resulting in increased back migration of the anion to decrease current efficiency.

In an exemplary embodiment of the present disclosure, the cation exchange membrane may be one or more selected from CM2, CMB, and CSE available from Astom, CD100 and CH100 available from W-Scope, TWEDC1S available from Shandong Tienwei, and CT-4 and CTG-10 available from Hangzhou Lanran.

A migration amount weight ratio (ω_{C}) between water (H₂O) and a lithium cation (Li⁺) in the cation exchange membrane of the electrodialysis device may be 40 or less, specifically 35 or less, and more specifically 20 to 35.

A migration amount weight ratio (ω_{C}) between water and a lithium cation per unit time in the cation exchange membrane may be represented by the following equation:

$${ω}_{C} = {H}_{2} O migration amount ( g ) / {Li}^{+} migration amount ( g ) \qquad ( 1 )$$

When the migration amount weight ratio (ω_{C}) value between water (H₂O) and a lithium cation (Li⁺) in the cation exchange membrane is 40, a significant decrease in current efficiency applied for producing lithium hydroxide may be prevented and electrical energy consumption may be reduced.

In the present disclosure, the ωc may be adjusted according to the type of polymer forming the cation exchange membrane, the type of fixed ion group, an ion exchange capacity, a membrane thickness, and the like. Even in the case in which the polymer forming the membrane, the type of fixed ion, and the membrane thickness are the same, ωc may vary when an ion exchange capacity (milli-equivalent/g-dry polymer) which is a proportion of the amount of the fixed ion group (moles) in the dry weight of the membrane changes. In addition, the ωc may vary also depending on the process conditions of the bipolar membrane electrodialysis device, that is, temperature, concentration, and the like.

In another exemplary embodiment of the present disclosure, a ratio (Q_{LH in}/Q_{LH out}) of a supply flow rate of a low-concentration lithium hydroxide (LiOH) aqueous solution added as a raw material to a discharge flow rate of a high concentration lithium hydroxide (LiOH) aqueous solution produced in the base chamber of the bipolar membrane electrodialysis device may be 0.3 to 0.6. When the ratio (Q_{LH in}/Q_{LH out}) value is less than 0.3, the concentration of the lithium hydroxide aqueous solution is increased, so that reverse migration by hydroxide ion (OH⁻) diffusion through the cation exchange membrane may be increased to lower current efficiency, and when the ratio (Q_{LH in}/Q_{LH out}) value is more than 0.6, the amount of water to be removed in the process of preparing crystalline lithium hydroxide in the latter stage is increased to lower entire productivity. Meanwhile, in the present disclosure, the concentration of the high concentration lithium hydroxide (LiOH) aqueous solution produced in the base chamber may be in a range of 1 mol/L to 5 mol/L, and the concentration of the low-concentration lithium hydroxide (LiOH) aqueous solution added as a raw material may be in a range of 0 mol/L to 1 mol/L. When the concentration of the produced lithium hydroxide (LiOH) aqueous solution is less than 1 mol/L, economic feasibility is poor, and when the concentration of the produced lithium hydroxide is more than 5 mol/L or more, back-diffusion through the cation exchange membrane is excessively increased to lower current efficiency. The lithium hydroxide (LiOH) aqueous solution added as a raw material may be pure water (lithium hydroxide concentration: 0 mol/L), and when the concentration is more than 1 mol/L, lithium hydroxide is excessively consumed to deteriorate economic feasibility.

In another exemplary embodiment of the present disclosure, a ratio (QHS in/QHS out) of a supply flow rate of a low concentration sulfuric acid (H₂SO₄) aqueous solution added to the acid chamber as a raw material to a discharge flow rate of a high-concentration sulfuric acid (H₂SO₄) aqueous solution produced in the acid chamber of the bipolar membrane electrodialysis device may be 0.9 to 1.2. When the ratio (QHS in/QHS out) value is less than 0.9, the concentration of the produced sulfuric acid (H₂SO₄) is too high to increase reverse migration of a hydrogen ion (proton) through the anion exchange membrane, thereby lowering current efficiency. In addition, when the ratio (QHS in/QHS out) value is more than 1.2, the concentration of the produced sulfuric acid (H₂SO₄) is too thin, so that utility of the produced sulfuric acid as a product is low. Meanwhile, the concentration of the high-concentration sulfuric acid (H₂SO₄) aqueous solution produced in the acid chamber may be in a range of 0.5 mol/L to 3 mol/L, and the concentration of the low-concentration sulfuric acid (H₂SO₄) aqueous solution added as a raw material may be in a range of 0 mol/L to 0.5 mol/L. When the concentration of the produced sulfuric acid aqueous solution is 0.5 mol/L or less, economic feasibility is poor, and when the concentration is more than 3 mol/L or more, back-diffusion of a hydrogen ion (H⁺) through the anion exchange membrane is excessive to lower current efficiency. The sulfuric acid (H₂SO₄) aqueous solution added as a raw material may be pure water (sulfuric acid concentration: 0 mol/L), and when the concentration is more than 0.5 mol/L, the sulfuric acid is excessively consumed to deteriorate economic feasibility.

Meanwhile, in the present disclosure, the concentration of the lithium sulfate aqueous solution added to the salt chamber of the bipolar membrane electrodialysis device may be 0.5 mol/L to 2.5 mol/L, and the concentration of the lithium sulfate aqueous solution discharged from the salt chamber of the electrodialysis device may be 0.1 mol/L to 2 mol/L. When the concentration of the added lithium sulfate aqueous solution is less than 0.5 mol/L, resistance of the salt aqueous solution is increased, so that operation is not easy, and when the concentration is 2.5 mol/L or more, solubility in water approaches to limit, so that operation is not easy. In addition, the concentration of the lithium sulfate aqueous solution (desalination solution) discharged from the salt chamber of the electrodialysis device is less than 0.1 mol/L, resistance of the salt aqueous solution is excessively increased, so that operation at a high current density is difficult, and when the concentration is more than 2 mol/L, a device size is too large and economic feasibility is poor.

In another exemplary embodiment of the present disclosure, a current density passing through a membrane (cation exchange membrane and anion exchange membrane) may be 20 mA/cm² to 150 mA/cm² (based on membrane effective area), and specifically 50 mA/cm² to 100 mA/cm². When the current density is less than 20 mA/cm², a production (kg/m²-hr) of lithium hydroxide (LiOH) or sulfuric acid (H₂SO₄) is too low, and when the current density is more than 150 mA/cm², resistance is too high, resulting in deterioration (such as blistering, delamination, and aging) of the ion exchange membrane, in particular, the bipolar membrane.

In the present disclosure, the membrane current density may be supplied by a rectifier considering the effective membrane area. Herein, the current density may be in a range where a temperature rise and membrane deterioration do not occur by various resistances which may occur in the bipolar membrane electrodialysis device.

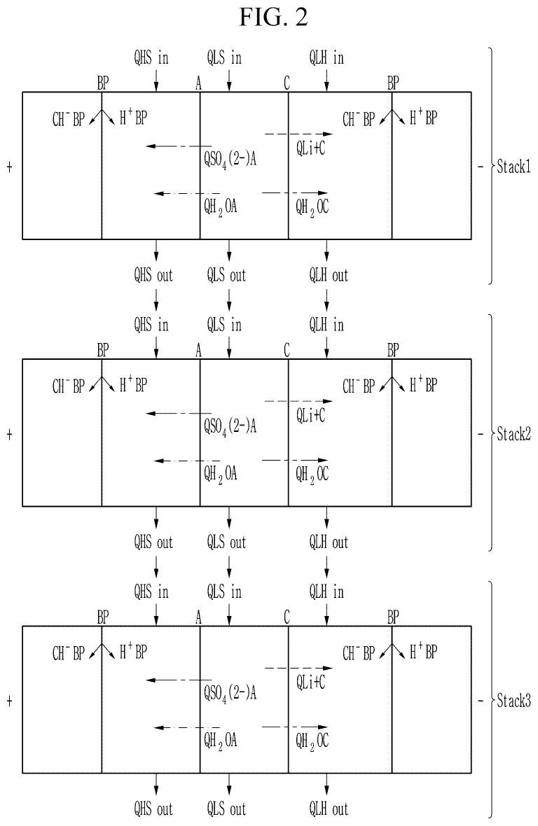

FIG. 2 schematically shows a bipolar membrane electrodialysis (BPED) system used in an experiment of lithium hydroxide and sulfuric acid preparation of the present disclosure.

In an exemplary embodiment of the present disclosure, the bipolar membrane electrodialysis (BPED) system may include an electrodialysis stack including one or more pairs in which a cation exchange membrane (C), an anion exchange membrane (A), and a bipolar membrane (BP) are sequentially arranged.

In addition, two or more stacks may be connected in series. Herein, the membrane current density of the serially connected stacks may be gradually decreased.

FIG. 2 illustrates that the material discharged from the stack in the former stage directly flows in the stack in the latter stage for convenience, but a part of the material discharge from the stack in the former stage may be separated to the outside and only a remainder may be supplied to the stack in the latter stage, and the material discharged from the stack in the front stage may be mixed with an additional raw material and supplied to the stack in the latter stage. It is not particularly limited as long as the purpose of the present disclosure is achieved.

### (Experiment of Lithium Hydroxide and Sulfuric Acid Preparation)

3 stacks formed by stacking 40 pairs (effective membrane area: 0.5 m²) in which a cation exchange membrane (C), an anion exchange membrane (A), and a bipolar membrane (BP) were sequentially arranged were connected in series to form a BPED system.

FIG. 2 schematically shows the BPED system used in the experiment of lithium hydroxide and sulfuric acid preparation of the present disclosure.

The cation exchange membrane C may be one or more selected from CM2, CMB, and CSE available from Astom, CD100 and CH100 available from W-Scope, TWEDC1S available from Shandong Tienwei, and CT-4 and CTG-10 available from Hangzhou Lanran, and the cation exchange membranes used in Stacks 1 to 3 may be the same as or different from each other.

The anion exchange membrane A may be one or more selected from ASE, AID, and ACD available from Astom, AD100 available from W-Scocpe, TWEDA1R available from Shandong Tienwei, and ATD available from Hangzhou Lanran, and the anion exchange membranes used in Stacks 1 to 3 may be the same as or different from each other.

The bipolar membrane BP may be one or more selected from BP-1 and BPU available from Astom, FBM available from Fumatech, TRJBM available from Beijing Tingrun, and BP-2 available from Hangzhou Lanran, and the bipolar membranes used in Stacks 1 to 3 may be the same as or different from each other.

Solution flow in the stack will be described in detail referring to FIG. 2.

A lithium sulfate (Li₂SO₄) salt aqueous solution at a Li concentration of 10 g/L was supplied (lithium sulfate supply amount: Q_{LS in} (kg/hr)) between the anion exchange membrane (A) and the cation exchange membrane (C), water (deionized water, deionized water (DIW)) or a mixture of a lithium hydroxide aqueous solution and water (DIW)) was supplied (supply amount: Q_{LH in} (kg/hr)) between the cation exchange membrane (C) and the bipolar membrane (BP), and water (DIW) or a mixture of water and a sulfuric acid aqueous solution was supplied (supply amount: Q_{HS in} (kg/hr)) between the bipolar membrane (BP) and the anion exchange membrane (A). Positive (+) direct current electricity was applied to an electrode positioned at the end of the stack in the anion exchange membrane (A) side, and negative (−) direct current electricity was applied to an electrode positioned at the end of the stack in the cation exchange membrane (C) side, based on the salt chamber to which the lithium sulfate salt is supplied.

Specifically, the amount of lithium hydroxide (LiOH) (Q_{LH out} (kg/hr)) and the amount of sulfur acid (H₂SO₄) (QHS out (kg/hr) which were produced by applying electricity to Stack 1 at a size of an ion exchange membrane current density of 77 mA/cm², Stack 2 at a size of an ion exchange membrane current density of 73 mA/cm², and Stack 3 at a size of an ion exchange membrane current density of 60 mA/cm² and discharged were measured.

The amount of lithium ion (Li⁺) in the produced lithium hydroxide and the content of sulfur in the sulfuric acid were measured by an ion coupled chromatography (ICP) method.

Most of the lithium content in the lithium hydroxide may be regarded as a lithium ion (Li⁺) value (Q_{Li+c} (kg/hr) migrating through the cation exchange membrane, and most of the S value in the sulfuric acid may be regarded as a value (Q_{SO4 2-A} (kg/hr)) of the sulfate ion (SO₄²⁻) migrating through the anion exchange membrane. The sulfate migration amount was calculated from a sulfur migration amount.

The amount of water migrating with the lithium ion through the cation exchange membrane (Q_{H2O C} (kg/hr)) may be calculated as follows:

$$( {Q}_{H 2 O C} ) = ( {Q}_{LH out} ) - ( {Q}_{LH in} ) - ( {Q}_{Li + C} ) \qquad ( 2 )$$

However, the amount of water (H₂O) flowing in the bipolar membrane in the base chamber and the amount of the hydroxide ion (OH⁻) produced by water dissociation in the bipolar membrane and supplied to the base chamber may be offset each other in a normal state and are neglectable.

A weight ratio (parameter, ω_{C}) between water and a lithium ion migrating through the cation exchange membrane was calculated as follows:

$${ω}_{C} = ( {Q}_{H 2 O C} ) / ( {Q}_{Li + C} ) \qquad ( 3 )$$

The amount of water (Q_{H2O A} (kg/hr)) migrating with a sulfate ion through the anion exchange membrane may be calculated as follows:

$$( {Q}_{H 2 O A} ) = ( {Q}_{HS out} ) - ( {Q}_{HS in} ) - ( {Q}_{SO 42 - A} ) \qquad ( 4 )$$

However, the amount of water flowing in the bipolar membrane in the acid chamber and the amount of the hydrogen ion (H⁺) produced by water dissociation in the bipolar membrane and supplied to the acid chamber may be offset each other in a normal state and is neglectable.

A weight ratio (parameter, ω_{A}) of water and a sulfate ion migrating through the anion exchange membrane was calculated as follows:

$${ω}_{A} = ( {Q}_{H 2 O A} ) / ( {Q}_{SO42 - A} ) \qquad ( 5 )$$

Operation was performed in a rectifier mode in which voltage sum was similarly adjusted, and the current efficiency was calculated as follows from the amount of produced lithium:

$$Current efficiency ( \% ) = 100 \times \{ Li production amount ( mol ) \times Faraday constant ( C / mol ) \} / \{ current density A / {m}^{2} \times membrane area ( {m}^{2} ) \times time ( sec ) \} \qquad ( 6 )$$

### MODE FOR INVENTION

### Example 1

In Example 1, lithium hydroxide and sulfuric acid were prepared by using CH100 available from W-Scope as a cation exchange membrane, A100 available from W-Scope as an anion exchange membrane, and BPU available from Astom as a bipolar membrane. Meanwhile, in Stacks 1 to 3, the same cation exchange membrane, anion exchange membrane, and bipolar membrane were used.

Meanwhile, a ratio (Q _{LH in}/Q _{LH out}) of a flow rate of the lithium hydroxide aqueous solution supplied to the stack to a flow rate of the lithium hydroxide aqueous solution discharged from the stack was 0.36, and a ratio (Q _{HS in}/Q _{HS out}) of a flow rate of the sulfuric acid aqueous solution supplied to the stack to a flow rate of the sulfuric acid aqueous solution discharged from the stack was 1.03.

### Example 2

In Example 2, lithium hydroxide and sulfuric acid were prepared by using CD100 available from W-Scope as a cation exchange membrane, AD100 available from W-Scope as an anion exchange membrane, and FBM available from Fumatech as a bipolar membrane. Meanwhile, in Stacks 1 to 3, the same cation exchange membrane, anion exchange membrane, and bipolar membrane were used.

Meanwhile, a ratio (Q _{LH in}/Q _{LH out}) of a flow rate of the lithium hydroxide aqueous solution supplied to the stack to a flow rate of the lithium hydroxide aqueous solution discharged from the stack was 0.43, and a ratio (Q _{HS in}/Q _{HS out}) of a flow rate of the sulfuric acid aqueous solution supplied to the stack to a flow rate of the sulfuric acid aqueous solution discharged from the stack was 1.05.

### Example 3

In Example 3, lithium hydroxide and sulfuric acid were prepared by using CH100 available from W-Scope as a cation exchange membrane, AD100 available from W-Scope as an anion exchange membrane, and FBM available from Fumatech as a bipolar membrane. Meanwhile, in Stacks 1 to 3, the same cation exchange membrane, anion exchange membrane, and bipolar membrane were used.

Meanwhile, a ratio (Q _{LH in}/Q _{LH out}) of a flow rate of the lithium hydroxide aqueous solution supplied to the stack to a flow rate of the lithium hydroxide aqueous solution discharged from the stack was 0.53, and a ratio (Q _{HS in}/Q _{HS out}) of a flow rate of the sulfuric acid aqueous solution supplied to the stack to a flow rate of the sulfuric acid aqueous solution discharged from the stack was 0.95.

### Comparative Example 1

In Comparative Example 1, lithium hydroxide and sulfuric acid were prepared by using a membrane (CH100′) of which the ion exchange capacity was changed from that of the membrane available from W-Scope as a cation exchange membrane, AD100 available from W-Scope as an anion exchange membrane, and FBM available from Fumatech as a bipolar membrane. Meanwhile, in Stacks 1 to 3, the same cation exchange membrane, anion exchange membrane, and bipolar membrane were used.

Meanwhile, a ratio (Q _{LH in}/Q _{LH out}) of a flow rate of the lithium hydroxide aqueous solution supplied to the stack to a flow rate of the lithium hydroxide aqueous solution discharged from the stack was 0.28, and a ratio (Q _{HS in}/Q _{HS out}) of a flow rate of the sulfuric acid aqueous solution supplied to the stack to a flow rate of the sulfuric acid aqueous solution discharged from the stack was 1.27.

The results of calculating flow rates and parameters (ω_{C}, ω_{A}) measured in Examples 1 to 3 and Comparative Example 1 are shown in the following Table 1:

TABLE 1

| | | | | | | | | | Cation | Anion | | |
|---|---|---|---|---|---|---|---|---|---|---|---|---|
| | | | | | | | | | exchange | exchange | | |
| | LiOH solution | | | | H₂SO₄ solution | | | | membrane | membrane | | Current |
| | Q_{LH in} | Q_{LH out} | Q_{Li+C} | Q_{H2O C} | Q_{HS in} | Q_{HS out} | S out A | QH₂O A | ωc | ωA | Voltage | efficiency |
| | (kg/hr) | (kg/hr) | (kg/hr) | (kg/hr) | (kg/hr) | (kg/hr) | (g/L) | (kg/hr) | (by wt) | (by wt) | sum (V) | (%) |
| Example 1 | 650 | 1807 | 37.3 | 1119.7 | 3113 | 3020 | 35.8 | −397.4 | 30.0 | −3.7 | 253 | 56 |
| Example 2 | 750 | 1728 | 30 | 948 | 3250 | 3080 | 31.9 | −446.6 | 31.6 | −4.7 | 283 | 50 |
| Example 3 | 950 | 1784 | 31.4 | 802.6 | 3100 | 3270 | 30.4 | −109.9 | 25.6 | −1.2 | 282 | 53.5 |
| Comparative | 550 | 1934 | 30.2 | 1353.8 | 3520 | 2770 | 38.3 | −1045.9 | 44.8 | −9.2 | 267 | 41.7 |
| Example 1 | | | | | | | | | | | | |

Referring to Table 1, it was shown that the current efficiency of the cation exchange membrane CH100′ of Comparative Example 1 having a ω_{C} value of 44.8 was 41.7%, which was significantly lower than those of Examples 1 to 3. The cation exchange membrane had a so-called Donnan exclusion effect in which anion migration is repelled and blocked by a fixed anion (co-ion) inside the membrane, and it is known that the higher the fixed anion density, the higher the Donan exclusion effect. However, when the ω_{C} value was 44.8, it is considered that the cation exchange membrane was excessively swollen by water to lower the fixed anion density inside the cation exchange membrane, resulting in a significant decrease in the Donan exclusion effect on an anion (OH⁻).

Therefore, it is considered that since the OH⁻ anion in the produced lithium hydroxide aqueous solution overcame the Donan exclusion effect by an anion (co-ion) of the swollen cation exchange membrane, back-migrated significantly more toward the lithium sulfate salt aqueous solution, and consumed current applied as much as the amount of back-migrating OH⁻ anion, current efficiency was decreased.

In Table 1, the migration amount ratio (ω_{A}) between water and sulfate migrating through the anion exchange membrane is represented as a negative number (−). The amount of water (H₂O) flowing in the bipolar membrane and the amount of the hydrogen ion (H⁺) produced by dissociation in the bipolar membrane in the acid chamber were represented as calculated values assuming that they may be offset each other, but actually, it is because the amount of inflowing water is larger than the amount of a discharged hydrogen ion.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

1. A method for simultaneously preparing lithium hydroxide and sulfuric acid, the method comprising:
preparing a bipolar membrane electrodialysis device including a first bipolar membrane, an anion exchange membrane, a cation exchange membrane, and a second bipolar membrane in which an acid chamber is formed between the first bipolar membrane and the anion exchange membrane, a salt chamber is formed between the anion exchange membrane and the cation exchange membrane, and a base chamber is formed between the cation exchange membrane and the second bipolar membrane;
adding a lithium sulfate aqueous solution to the salt chamber, adding a sulfuric acid aqueous solution to the acid chamber, and adding a lithium hydroxide aqueous solution to the base chamber of the bipolar membrane electrodialysis device; and
discharging a desalination solution formed in the salt chamber, discharging the sulfuric acid aqueous solution formed in the acid chamber, and discharging the lithium hydroxide aqueous solution formed in the base chamber of the bipolar membrane electrodialysis device,
wherein a migration amount weight ratio between water (H₂O) and a lithium cation (Li⁺) in the cation exchange membrane of the bipolar membrane electrodialysis device is 40 or less.

2. The method for simultaneously preparing lithium hydroxide and sulfuric acid of claim 1, wherein:
a ratio of a flow rate of the lithium hydroxide aqueous solution added to the base chamber to a flow rate of the lithium hydroxide aqueous solution discharged from the base chamber of the bipolar membrane electrodialysis device is 0.3 to 0.6.

3. The method for simultaneously preparing lithium hydroxide and sulfuric acid of claim 1, wherein:
a ratio of a flow rate of the sulfuric acid aqueous solution added to the acid chamber to a flow rate of the sulfuric acid aqueous solution discharged from the acid chamber of the bipolar membrane electrodialysis device may be 0.9 to 1.2.

4. The method for simultaneously preparing lithium hydroxide and sulfuric acid of claim 1, wherein:
a current density passing through the cation exchange membrane and the anion exchange membrane of the bipolar membrane electrodialysis device is 20 mA/cm² to 150 mA/cm².

5. The method for simultaneously preparing lithium hydroxide and sulfuric acid of claim 1, wherein:
a concentration of the lithium hydroxide aqueous solution added to the base chamber of the bipolar membrane electrodialysis device is 0 mol/L to 1 mol/L, and
a concentration of the lithium hydroxide aqueous solution discharged from the base chamber of the bipolar membrane electrodialysis device is 1 mol/L to 5 mol/L.

6. The method for simultaneously preparing lithium hydroxide and sulfuric acid of claim 1, wherein:
a concentration of the sulfuric acid aqueous solution added to the acid chamber of the bipolar membrane electrodialysis device is 0 mol/L to 0.5 mol/L, and
a concentration of the sulfuric acid aqueous solution discharged from the acid chamber of the bipolar membrane electrodialysis device is 0.5 mol/L to 3 mol/L.

7. The method for simultaneously preparing lithium hydroxide and sulfuric acid of claim 1, wherein:
a concentration of the lithium sulfate aqueous solution added to the salt chamber of the bipolar membrane electrodialysis device is 0.5 mol/L to 2.5 mol/L, and
a concentration of the lithium sulfate aqueous solution discharged from the salt chamber of the bipolar membrane electrodialysis device is 0.1 mol/L to 2 mol/L.

8. The method for simultaneously preparing lithium hydroxide and sulfuric acid of claim 1, wherein:
the bipolar membrane electrodialysis device is
two or more serially connected electrodialysis stacks including the first bipolar membrane, the anion exchange membrane, the cation exchange membrane, and the second bipolar membrane in which the acid chamber is formed between the first bipolar membrane and the anion exchange membrane, the salt chamber is formed between the anion exchange membrane and the cation exchange membrane, and the base chamber is formed between the cation exchange membrane and the second bipolar membrane.
